(19) United States
(12) Patent Application Publication
(10) Pub. No.: US 2013/0285621 A1
(43) Pub. Date: Oct. 31, 2013

(54) POWER SUPPLYING APPARATUS AND POWER CHARGING APPARATUS

(71) Applicant: SAMSUNG ELECTRO-MECHANICS CO., LTD., Suwon (KR)

(72) Inventors: Young Jin Cho, Suwon-Gyunggi-do (KR); Won Jin Cho, Suwon-Gyunggi-do (KR); Bu Won Lee, Suwon-Gyunggi-do (KR)

(73) Assignee: SAMSUNG ELECTRO-MECHANICS CO., LTD., Suwon (KR)

(21) Appl. No.: 13/769,131

(22) Filed: Feb. 15, 2013

(30) Foreign Application Priority Data
Apr. 27, 2012 (KR) 10-2012-0044831

(51) Int. Cl. H02M 7/04; H02J 7/00

(52) U.S. Cl. CPC H02M 7/04; H02J 7/007
USPC 320/162; 363/84

(57) ABSTRACT

There are provided a power supplying apparatus controlling voltage of a power factor correcting circuit according to a power state and a power charging apparatus controlling voltage of a power factor correcting circuit according to a charging state of a battery. The power supplying apparatus includes: a power factor correcting circuit switching input power to correct a power factor thereof and adjusting a voltage level of the power of which the power factor has been corrected according to a state of power transferred to a load; and a resonant DC to DC converting circuit having a resonance frequency varied according to a voltage level of DC power from the power factor correcting circuit and converting the DC power from the power factor correcting circuit into supply power having a preset level according to the resonance frequency.

### CROSS-REFERENCE TO RELATED APPLICATIONS

This application claims the priority of Korean Patent Application No. 10-2012-0044831 filed on Apr. 27, 2012, in the Korean Intellectual Property Office, the disclosure of which is incorporated herein by reference.

### BACKGROUND OF THE INVENTION

1. Field of the Invention

The present invention relates to a power supplying apparatus having increased power converting efficiency and a power charging apparatus having increased charging efficiency.

2. Description of the Related Art

Generally, in order to drive an electronic apparatus, a power supplying apparatus supplying driving power, required for driving, is necessarily required.

This power supplying apparatus generally converts commercial alternating current (AC) power into direct current (DC) driving power to supply the driving power to the electronic apparatus. However, in the power supplying apparatus, a voltage level at which a power converting circuit directly converting the commercial AC power into the driving power may maintain maximum power converting efficiency is limited, such that it is difficult to maintain high power converting efficiency in a wide input voltage level range. Further, in the case in which power is converted in a multi-step scheme, since the power is converted through several operations, power converting efficiency is reduced.

That is, in this power supplying apparatus, as described in the following Related Art Document, a power factor correcting circuit converting a rectified power into DC power and a DC-DC converting circuit converting the DC power into driving power capable of being used in an electronic apparatus may be employed. However, in this power supplying apparatus, power converting efficiency is reduced in a power converting process.

Meanwhile, in the case in which the electronic apparatus includes a battery, the above-mentioned power supplying apparatus may be a power charging apparatus providing charging power to be stored in the battery. However, even in this case, power converting efficiency is reduced in a power converting process.

### RELATED ART DOCUMENT

(Patent Document 1) Korean Patent Laid-open Publication No. 10-2009-0098569

### SUMMARY OF THE INVENTION

An aspect of the present invention provides a power supplying apparatus controlling voltage of a power factor correcting circuit according to a power state and a power charging apparatus controlling voltage of a power factor correcting circuit according to a charging state.

According to an aspect of the present invention, there is provided a power supplying apparatus including: a power factor correcting circuit switching input power to correct a power factor thereof and adjusting a voltage level of the power of which the power factor has been corrected according to a state of power transferred to a load; and a resonant direct current (DC) to DC converting circuit having a resonance frequency varied according to a voltage level of DC power from the power factor correcting circuit and converting the DC power from the power factor correcting circuit into supply power having a preset level according to the resonance frequency.

The power factor correcting circuit may lower the voltage level of the power of which the power factor has been corrected according to the state of the power transferred to the load.

The resonant DC to DC converting circuit may lower the resonance frequency according to the voltage level of the power lowered in the power factor correcting circuit.

The power factor correcting circuit may include a power factor correcting unit switching the input power to correct the power factor thereof and lowering the voltage level of the power of which the power factor has been corrected, and a first controlling unit controlling the lowering of the voltage level of the power in the power factor correcting unit according to the state of the power transferred to the load.

The resonant DC to DC converting circuit may include a converting unit converting the DC power from the power factor correcting unit into the supply power according to the resonance frequency, and a second controlling unit controlling the lowering of the resonance frequency according to the voltage level of the DC power from the power factor correcting circuit and transferring information on the state of the power transferred to the load to the first controlling unit.

The converting unit may convert the DC power from the power factor correcting circuit into the supply power in an inductor-inductor-capacitor (LLC) resonance scheme.

According to another aspect of the present invention, there is provided a power charging apparatus including: a power factor correcting circuit switching input power to correct a power factor thereof and adjusting a voltage level of the power of which the power factor has been corrected according to a charging state of a battery; a resonant DC to DC converting circuit having a resonance frequency varied according to a voltage level of DC power from the power factor correcting circuit and converting the DC power from the power factor correcting circuit into charging power having a preset level according to the resonance frequency; and a battery unit receiving the charging power and providing information on the charging state of the battery according to the received charging power.

The power factor correcting circuit may lower the voltage level of the power of which the power factor has been corrected according to the charging state of the battery.

The resonant DC to DC converting circuit may lower the resonance frequency according to the voltage level of the power lowered in the power factor correcting circuit.

The power factor correcting circuit may include a power factor correcting unit switching the input power to correct the power factor thereof and lowering the voltage level of the power of which the power factor has been corrected, and a first controlling unit controlling the lowering of the voltage level of the power in the power factor correcting unit according to the charging state of the battery.

The resonant DC to DC converting circuit may include a converting unit converting the DC power from the power factor correcting circuit into the charging power according to the resonance frequency, and a second controlling unit controlling the lowering of the resonance frequency according to the voltage level of the DC power from the power factor correcting circuit and transferring the information on the charging state of the battery to the first controlling unit.

The converting unit may convert the DC power from the power factor correcting circuit into the charging power in an inductor-inductor-capacitor (LLC) resonance scheme.

The battery unit may include a battery charging controlling unit providing the information on the charging state of the battery.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration diagram of a power supplying apparatus according to an embodiment of the present invention;

FIG. 2 is a schematic configuration diagram of a power charging apparatus according to an embodiment of the present invention;

FIG. 3 is a graph showing a relationship between a frequency and an alternating current (AC) resistance component; and

FIG. 4 is a graph showing a relationship between a voltage ratio and a resonance frequency according to an embodiment of the present invention.

### DETAILED DESCRIPTION OF THE EMBODIMENTS

Hereinafter, embodiments of the present invention will be described in detail with reference to the accompanying drawings so that they can be easily practiced by those skilled in the art to which the present invention pertains.

However, in describing embodiments of the present invention, detailed descriptions related to well-known functions or configurations will be ruled out in order not to unnecessarily obscure subject matters of the present invention.

In addition, like or similar reference numerals denote parts performing similar functions and actions throughout the drawings.

It will be understood that when an element is referred to as being “connected to” another element, it can be directly connected to the other element or may be indirectly connected to the other element with element(s) interposed therebetween.

In addition, unless explicitly described to the contrary, the word “comprise” and variations such as “comprises” or “comprising,” will be understood to imply the inclusion of stated elements but not the exclusion of any other elements.

Embodiments of the present invention will now be described in detail with reference to the accompanying drawings.

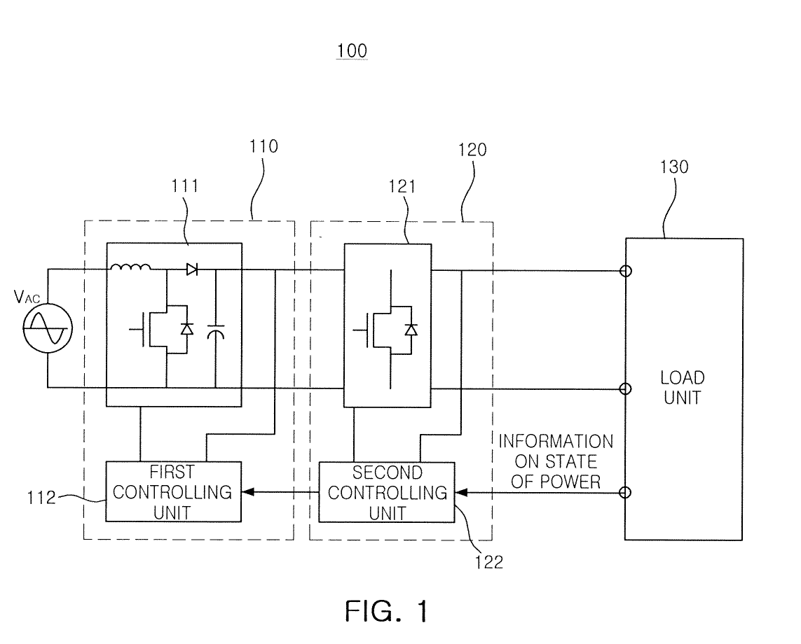

FIG. 1 is a schematic configuration diagram of a power supplying apparatus according to an embodiment of the present invention.

Referring to FIG. 1, a power supplying apparatus 100 according to the embodiment of the present invention may include a power factor correcting circuit 110 and a resonant direct current to direct current (DC to DC) converting circuit 120.

The power factor correcting circuit 110 may include a power factor correcting unit 111 and a first controlling unit 112.

The power factor correcting unit 111 may switch input power to adjust a phase difference between voltage and current of the power, thereby correcting a power factor. In addition, the power factor correcting unit 111 may variably adjust a voltage level of DC power of which the power factor has been corrected according to the switching operation. The variable adjustment of the voltage level may be controlled by the first controlling unit 112.

The first controlling unit 112 may control the adjustment of the voltage level of the DC power of which the power factor has been corrected according to the switching of the power factor correcting unit 111 according to information on a state of supply power, and the power factor correcting unit 111 may provide the DC power of which the voltage level is adjusted according to the controlling of the first controlling unit 112, to the resonant DC to DC converting circuit 120.

The power factor correcting unit 111 may provide the DC power having a lowered voltage level to the resonant DC to DC converting circuit 120.

The resonant DC to DC converting circuit 120 may include a converting unit 121 and a second controlling unit 122.

The converting unit 121 may convert the DC power from the power factor correcting unit 111 into supply power having a preset level. The converting unit 121 may convert the DC power from the power factor correcting unit 111 into the supply power in a preset resonance scheme.

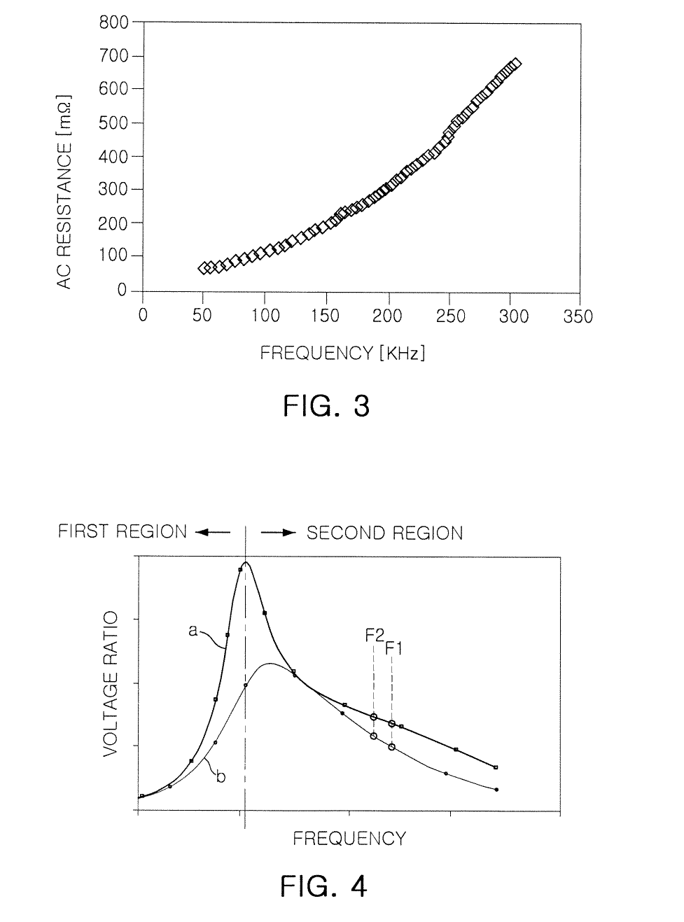

In this case, the converting unit 121 may perform a power converting operation using a resonance frequency. The resonance frequency may be affected by the voltage level of the DC power. A detailed description thereof will be provided below with reference to FIGS. 3 and 4.

The second controlling unit 122 may set the resonance frequency according to information on the state of the power transferred from a load unit 130 to control the power converting operation of the converting unit 121.

When the voltage level of the DC power is lowered in the power factor correcting unit 111, a frequency value of the resonance frequency may be lowered.

The information on the state of the power provided to the second controlling unit 122 may be transferred to the first controlling unit 112.

Meanwhile, the power supplying apparatus according to the embodiment of the present invention described above may be used as a power charging apparatus.

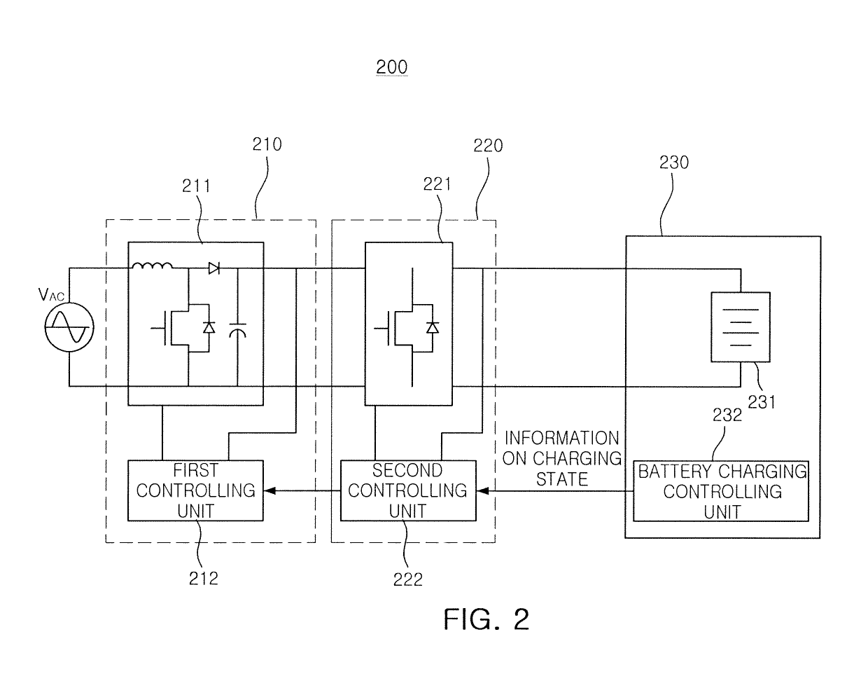

FIG. 2 is a schematic configuration diagram of a power charging apparatus according to an embodiment of the present invention.

Referring to FIG. 2, a power charging apparatus 200 according to the embodiment of the present invention may include a power factor correcting circuit 210 and a resonant DC to DC converting circuit 220.

The power factor correcting circuit 210 may include a power factor correcting unit 211 and a first controlling unit 212, similar to the power factor correcting circuit 110 of FIG. 1.

The power factor correcting unit 211 may lower a voltage level of DC power according to controlling by the first controlling unit 212, and the first controlling unit 212 may control the adjustment of the voltage level of the DC power of the power factor correcting unit 211 according to information on a charging state, unlike the first controlling unit 112 of FIG. 1.

In addition, the resonant DC to DC converting circuit 220 may include a converting unit 221 and a second controlling unit 222.

The converting unit 221 may convert the DC power from the power factor correcting unit 211 into charging power in a preset resonance scheme according to controlling by the second controlling unit 222. The second controlling unit 222 may adjust a resonance frequency value of the converting unit 221 according to the information on the charging state, unlike the second controlling unit 122 FIG. 1.

More specifically, the second controlling unit 222 may receive information regarding a current voltage/current level of a battery and a target voltage/current level thereof and determine voltage and current levels of the charging power according to the target voltage/current level included in the information on the charging state to control a power converting operation of the converting unit 221.

In addition, the second controlling unit 222 may provide the target voltage level of the DC power to the first controlling unit 212, and the first controlling unit 212 may control power switching of the power factor correcting unit 211 according to the target voltage level.

In this case, the first controlling unit 212 may determine the voltage level of the DC power within a range in which a problem does not occur in power factor correction according to an AC voltage level state of input power. Here, the adjusted voltage level of the DC power may be larger than a feed voltage level of the AC voltage of the input power.

In addition, the power charging apparatus 200 according to the embodiment of the present invention may further include a battery unit 230. The battery unit 230 may include a battery 231 receiving the charging power from the resonant DC to DC converting circuit 220 to thereby be charged with the charging power and a battery charging controlling unit 232 controlling a charging state of the battery 231 and providing information on the charging state of the battery 231 to the second controlling unit 222.

FIG. 3 is a graph showing a relationship between a frequency and an AC resistance component.

First, the resonant DC to DC converting circuit 120 or 220 may convert power in a preset resonance scheme. Therefore, although not shown, the resonant DC to DC converting circuit 120 or 220 may generally include a switch switching power and a transformer varying a voltage level of the power and may further include passive devices such as an inductor, a capacitor, and the like, according to a resonance scheme. As the resonance scheme, various schemes using a resonance frequency may be used. For example, an inductor-inductor-capacitor (LLC) resonance scheme may be used.

In the case of devices using a coil, such as a transformer and an inductor, winding loss according to an operating frequency may be generated, which may be in proportion to AC resistance.

Referring to FIG. 3, the frequency and the AC resistance may be in proportion to each other.

That is, when an operating frequency is high, AC resistance is increased, such that the winding loss may increase in the device using the coil, such as the transformer and the inductor. Further, in the case of switching the power, switching loss may increase.

FIG. 4 is a graph showing a relationship between a voltage ratio and a resonance frequency according to the embodiment of the present invention.

More specifically, the graph of FIG. 4 shows a relationship between a resonance frequency and a voltage ratio between the voltage level of the DC power from the power factor correcting circuit 110 or 210 and the voltage level of the supply power or the charging power transferred from the resonant DC to DC converting circuit 120 or 220 to the load unit 130 or the battery 231.

Referring to FIG. 4, the supply power or the charging power from the resonant DC to DC converting circuit 120 or 220 may have a resonance curve of high voltage and low current ‘a’ or low voltage and high current ‘b’.

The above-mentioned resonance curve may have first and second regions respectively positioned at the left and the right based on a maximum resonance point frequency. In the case in which the resonance frequency is significantly lower than the maximum resonance point frequency, volume of the passive device increases, such that the first region is not used.

That is, in the second region of the resonance curve, the voltage ratio between the voltage level of the DC power and the voltage level of the supply power or the charging power and the resonance frequency may be in inverse proportion to each other. More specifically, when the voltage ratio increases, the resonance frequency may decrease.

For example, in the case in which the voltage level of the DC power from the power factor correcting circuit 110 or 210 is 400V, when the voltage level of the supply power or the charging power is set to 200V and power conversion is performed, a voltage ratio may be 0.5. However, in the case in which the voltage level of the DC power from the power factor correcting circuit 110 or 210 is lowered to 350V according to a power state or a charging state, when the voltage level of the supply power or the charging power is set to 200V and power conversion is performed, a voltage ratio may be 0.57.

In this case, it may be appreciated that a frequency F2 when the voltage ratio is 0.57 is lower than a frequency F1 when the voltage ratio is 0.5. Therefore, winding loss and switching loss may be reduced according to an electrical relationship as shown in FIG. 3.

As set forth above, according to the embodiments of the present invention, a voltage level of a power factor correcting circuit is controlled according to a power state or a charging state to significantly reduce shifting of a resonance frequency of a resonant circuit and reduce switching loss and winding loss, whereby power converting efficiency may be increased.

While the present invention has been shown and described in connection with the embodiments, it will be apparent to those skilled in the art that modifications and variations can be made without departing from the spirit and scope of the invention as defined by the appended claims.

What is claimed is:

1. A power supplying apparatus comprising:
a power factor correcting circuit switching input power to correct a power factor thereof and adjusting a voltage level of the power of which the power factor has been corrected according to a state of power transferred to a load; and
a resonant direct current (DC) to DC converting circuit having a resonance frequency varied according to a voltage level of DC power from the power factor correcting circuit and converting the DC power from the power factor correcting circuit into supply power having a preset level according to the resonance frequency.

2. The power supplying apparatus of claim 1, wherein the power factor correcting circuit lowers the voltage level of the power of which the power factor has been corrected according to the state of the power transferred to the load.

3. The power supplying apparatus of claim 2, wherein the resonant DC to DC converting circuit lowers the resonance frequency according to the voltage level of the power lowered in the power factor correcting circuit.

4. The power supplying apparatus of claim 3, wherein the power factor correcting circuit includes:
a power factor correcting unit switching the input power to correct the power factor thereof and lowering the voltage level of the power of which the power factor has been corrected; and
a first controlling unit controlling the lowering of the voltage level of the power in the power factor correcting unit according to the state of the power transferred to the load.

5. The power supplying apparatus of claim 4, wherein the resonant DC to DC converting circuit includes:
a converting unit converting the DC power from the power factor correcting unit into the supply power according to the resonance frequency; and
a second controlling unit controlling the lowering of the resonance frequency according to the voltage level of the DC power from the power factor correcting circuit and transferring information on the state of the power transferred to the load to the first controlling unit.

6. The power supplying apparatus of claim 5, wherein the converting unit converts the DC power from the power factor correcting circuit into the supply power in an inductor-inductor-capacitor (LLC) resonance scheme.

7. A power charging apparatus comprising:
a power factor correcting circuit switching input power to correct a power factor thereof and adjusting a voltage level of the power of which the power factor has been corrected according to a charging state of a battery;
a resonant DC to DC converting circuit having a resonance frequency varied according to a voltage level of DC power from the power factor correcting circuit and converting the DC power from the power factor correcting circuit into charging power having a preset level according to the resonance frequency; and
a battery unit receiving the charging power and providing information on the charging state of the battery according to the received charging power.

8. The power charging apparatus of claim 7, wherein the power factor correcting circuit lowers the voltage level of the power of which the power factor has been corrected according to the charging state of the battery.

9. The power charging apparatus of claim 8, wherein the resonant DC to DC converting circuit lowers the resonance frequency according to the voltage level of the power lowered in the power factor correcting circuit.

10. The power charging apparatus of claim 9, wherein the power factor correcting circuit includes:
a power factor correcting unit switching the input power to correct the power factor thereof and lowering the voltage level of the power of which the power factor has been corrected; and
a first controlling unit controlling the lowering of the voltage level of the power in the power factor correcting unit according to the charging state of the battery.

11. The power charging apparatus of claim 10, wherein the resonant DC to DC converting circuit includes:
a converting unit converting the DC power from the power factor correcting circuit into the charging power according to the resonance frequency; and
a second controlling unit controlling the lowering of the resonance frequency according to the voltage level of the DC power from the power factor correcting circuit and transferring the information on the charging state of the battery to the first controlling unit.

12. The power charging apparatus of claim 11, wherein the converting unit converts the DC power from the power factor correcting circuit into the charging power in an inductor-inductor-capacitor (LLC) resonance scheme.

13. The power charging apparatus of claim 7, wherein the battery unit includes a battery charging controlling unit providing the information on the charging state of the battery.
